(19) United States
(12) Patent Application Publication
(10) Pub. No.: US 2011/0156574 A1
(43) Pub. Date: Jun. 30, 2011

(54) IMAGE DISPLAY APPARATUS USING PHOSPHOR PARTICLES

(75) Inventors: Kiyokatsu Ikemoto, Yokohama-shi (JP); Akinari Takagi, Yokosuka-shi (JP)

(73) Assignee: CANON KABUSHIKI KAISHA, Tokyo (JP)

(21) Appl. No.: 12/970,115

(22) Filed: Dec. 16, 2010

(30) Foreign Application Priority Data
Dec. 25, 2009 (JP) 2009-296242

(51) Int. Cl. H01J 1/62

(52) U.S. Cl. 313/502

(57) ABSTRACT

The image display apparatus includes a light transmissive substrate, and plural pixels arranged on a further inner side than the substrate. Each pixel includes a light emission layer in which phosphor particles are dispersed in a background medium having a same refractive index as that of the phosphor particle, and an excitation source exciting the phosphor particles to cause them to emit light. Each pixel further includes a refractive index distribution structure disposed between the substrate and the light emission layer and having a periodic refractive index distribution in a direction along an inner surface of the substrate.

### BACKGROUND OF THE INVENTION

1. Field of the Invention

The present invention relates to an image display apparatus that excites phosphor particles contained in pixels to cause them to emit light, and thereby displays images.

2. Description of the Related Art

As such an image display apparatus, an apparatus having a pixel structure shown in FIG. 10 is known. FIG. 10 shows one pixel 1002, and arranging a plurality of such pixels 1002 constitutes an image display apparatus 1000.

The pixel 1002 is disposed on a further inner side than a substrate 1001. The substrate 1001 is a visible light transmissive plate formed of glass or plastic.

The pixel 1002 is constituted by a light emission layer 1003 that includes phosphor particles 1005 and an excitation source 1004 for exciting the phosphor particles 1005. The light emission layer 1003 is formed by disposing the phosphor particles 1005 in an area 1006 having a certain degree of vacuum. A medium provided around the phosphor particles 1005 is referred to as a “background medium”. The phosphor particles 1005 are dispersed in the background medium.

The excitation source 1004 is formed by arranging electron emission elements and electrodes on a front face of a substrate, and providing electrodes on a back face of the light emission layer 1003. Applying an electric field to the electron emission elements causes them to emit electrons toward the light emission layer 1003, and supplying the electrons to the phosphor particles 1005 excites them to cause light emission. Moreover, another configuration of the excitation source 1004 is formed by arranging electrodes on a front face of a substrate, and arranging cells and electrodes on a front face or a back face of the light emission layer. The cell encloses gas that generates plasma in response to electric current application to generate ultraviolet light. The phosphor particles 1005 are irradiated with the ultraviolet light generated from the gas, thereby being excited.

The exited phosphor particles 1005 emit light of a wavelength according to a material thereof. The emitted light is transmitted through the substrate 1001 to exit from the apparatus 1000 to an external area as display light 1007.

Image display apparatuses are generally required to have a high display luminance and a high contrast. In order to increase the display light (exiting light) 1007 in the image display apparatus 1000 shown in FIG. 10, it is important to decrease loss of light generated in the light emission layer 1003 before it exits to the external area. A significant factor of the loss of light is an influence of total reflection at an interface between the light emission layer 1003 and the substrate 1001 or at an interface between the substrate 1001 and the external area.

U.S. Pat. No. 5,779,924 and Japanese Patent Laid-Open No. 2005-026140 disclose, as methods for increasing light exiting from a light emission element such as an LED by suppressing total reflection at an interface of two layers formed of materials whose refractive indices are mutually different, methods providing between the two layers a minute structure (refractive index distribution structure) whose refractive index changes at a period of about a wavelength of light.

The light emission element disclosed in U.S. Pat. No. 5,779,924 has a substrate, a clad layer, an active layer and an electrode layer, and is provided with the refractive index distribution structure between an external area of the element and the clad layer or between the external area and the substrate. In this light emission element, the refractive index distribution structure diffracts light generated in the element, thereby decreasing totally reflected light to increase the exiting light.

Moreover, in order to improve contrast of the image display apparatus 1000 shown in FIG. 10, it is important to suppress reflection of external light so as to lower a lowest luminance in black display. The external light entering the image display apparatus 1000 from the external area is reflected in the apparatus to exit to the external area. This light reflected and exiting to the external area is referred to as “external reflected light 1010”. The external reflected light 1010 can be classified into regular (specular) reflected light 1008 and diffuse reflected light 1009. When an axis extending in a direction orthogonal to a display screen of the image display apparatus is defined as a z-axis, the regular reflected light is, in a case where the external light enters the apparatus from a direction forming an angle of θ with the z-axis and is then reflected by the apparatus, part of the reflected light which exits to the external area in a direction forming an angle of −θ with the z-axis. On the other hand, the diffuse reflected light is, in a case where the external light enters the apparatus and is then reflected by the apparatus to exit to the external area, part of the reflected light other than the regular reflected light.

A factor increasing the external reflected light 1010 in the image display apparatus 1000 is the diffuse reflected light 1009 generated in the light emission layer 1003. The phosphor particles 1005 used for a color cathode-ray tube are generally formed of a medium having a refractive index of 1.5-2.5, and have a particle diameter of several μm. Entrance of light into the light emission layer 1003 in which such phosphor particles 1005 are dispersed causes reflection at an interface between the phosphor particles 1005 and the area (background medium) 1006 therearound due to their refractive index difference. The light reflected at the interface between each phosphor particle 1005 and the background medium 1006 proceeds in various directions according to shapes of the phosphor particles 1005.

A part of the reflected light exits to the external area, and another part thereof is reflected at surfaces of other phosphor particles 1005 several times and then exits to the external area, these exiting lights becoming the external reflected light 1010. When the external light 1010 enters the image display apparatus 1000 from the direction orthogonal to the display screen thereof, light reflected in the direction orthogonal to the display screen is the regular reflected light 1008, and light reflected in other directions is the diffuse reflected light 1009.

In the image display apparatus 1000, increase of this diffuse reflected light 1009 increases luminance of the entire display screen, which deteriorates the contrast. Therefore, in order to improve the contrast, it is necessary to decrease the diffuse reflected light 1009.

Japanese Patent Laid-Open No. 2005-026140 discloses a method for decreasing such diffuse reflected light in an image display apparatus using phosphor particles. This disclosed method uses a light emission layer in which a surrounding area of the phosphor particles is filled with alkaline silicate. Japanese Patent Laid-Open No. 2005-026140 describes that use of such a light emission layer enables reduction of a refractive index difference between the phosphor particles and their surrounding area, which can decrease reflected light generated at surfaces of the phosphor particles and thereby can decrease the diffuse reflected light.

Filling the surrounding area of the phosphor particles with the medium as the method disclosed in Japanese Patent Laid-Open No. 2005-026140 increases an effective refractive index of the light emission layer. Such increase of the effective refractive index of the light emission layer increases a refractive index difference at the interface between the light emission layer and the substrate, which increases Fresnel reflection at the interface between the light emission layer and the substrate, and thereby increases the regular reflected light. Furthermore, decrease of the diffuse reflected light in the light emission layer increases light passing through the light emission layer and then reaching a back face thereof. This light is reflected by the back face of the light emission layer, and propagates through the light emission layer and the substrate to exit to the external area as the regular reflected light. Therefore, the filling of the surrounding area of the phosphor particles with the medium decreases the diffuse reflected light but increases the regular reflected light. Thus, the method disclosed in Japanese Patent Laid-Open No. 2005-026140 has a small effect to decrease the external reflected light, in other words, a small effect to improve the contrast.

Moreover, the increase of the effective refractive index of the light emission layer increases the refractive index difference at the interface between the light emission layer and the substrate, which reduces a total reflection angle and therefore decreases display light that is part of the light generated in the light emission layer and exits to the external area through the substrate.

### SUMMARY OF THE INVENTION

The present invention provides an image display apparatus that uses phosphor particles and is capable of displaying bright and high-contrast images.

The present invention provides as an aspect thereof an image display apparatus including a light transmissive substrate, and plural pixels arranged on a further inner side than the substrate. Each pixel includes a light emission layer in which phosphor particles are dispersed in a background medium having a same refractive index as that of the phosphor particle, an excitation source exciting the phosphor particles to cause them to emit light, and a refractive index distribution structure disposed between the substrate and the light emission layer and having a periodic refractive index distribution in a direction along an inner surface of the substrate.

Further features of the present invention will become apparent from the following description of exemplary embodiments with reference to the attached drawings.

### BRIEF DESCRIPTION OF THE DRAWINGS

FIG. 1 is a cross-sectional view showing a configuration of an image display apparatus that is Embodiment 1 of the present invention.

FIG. 2 shows propagation of reflected diffracted light generated at a refractive index distribution structure when external light enters the image display apparatus of Embodiment 1 from an external area from a direction orthogonal to a display screen thereof.

FIG. 3 shows propagation of transmitted diffracted light generated at the refractive index distribution structure when the external light enters the image display apparatus of Embodiment 1 from the external area from the direction orthogonal to the display screen thereof.

FIG. 4 shows propagation of light generated in a light emission layer in the image display apparatus of Embodiment 1.

FIGS. 5A and 5B show an example of the refractive index distribution structure in the image display apparatus of Embodiment 1.

FIG. 6 shows regular reflectance and diffuse reflectance when light of a wavelength of 550 nm enters the image display apparatus of Embodiment 1 from the external area.

FIG. 7 shows intensity of light exiting to the external area when light is generated inside the light emission layer toward the external area in Embodiment 1.

FIG. 8 is a cross-sectional view showing a configuration of the image display apparatus that is Embodiment 2 of the present invention.

FIGS. 9A to 9C show examples of a refractive index distribution structure in the image display apparatus of Embodiment 2.

FIG. 10 is a cross-sectional view showing a configuration of a conventional image display apparatus.

### DESCRIPTION OF THE PREFERRED EMBODIMENTS

Exemplary embodiments of the present invention will hereinafter be described with reference to the accompanying drawings.

### Embodiment 1

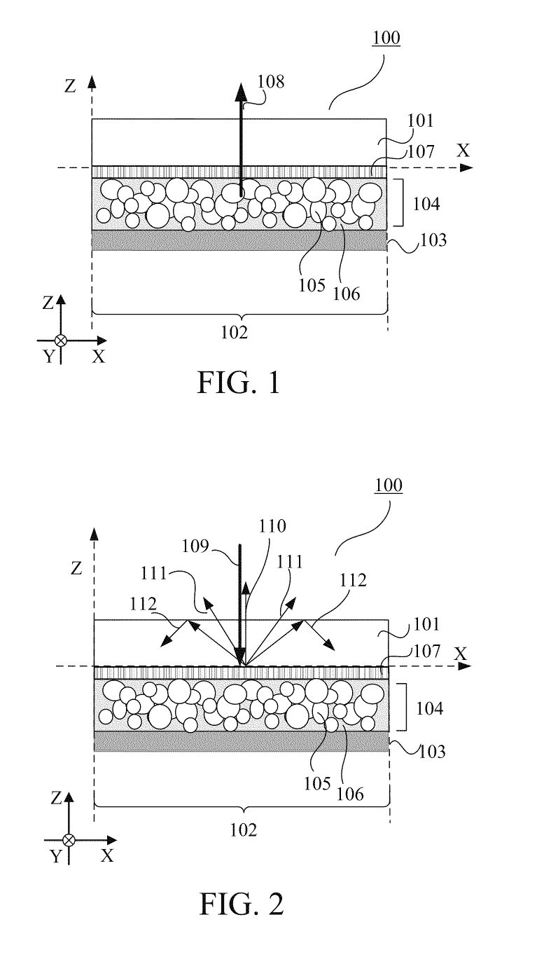

FIG. 1 schematically shows a configuration of an image display apparatus 100 that is a first embodiment (Embodiment 1) of the present invention. FIG. 1 shows an x-z cross section of the image display apparatus 100.

The image display apparatus 100 is constituted by a light transmissive substrate 101 and plural pixels 102 arranged on a further inner side (back side) than the substrate 101. Although only one pixel 102 is shown in FIG. 1, the plural pixels 102 are two-dimensionally arranged along an inner face of the substrate 101 to realize the image display apparatus 100 capable of displaying two-dimensional images.

The substrate 101 is formed of a visible light transmissive (transparent) medium such as glass or plastic.

The pixel 102 is constituted by a light emission layer 104, a refractive index distribution structure 107 that is a minute periodic structure, and an excitation source 103. The refractive index distribution structure 107 is disposed between the substrate 101 and the light emission layer 104. The excitation source 103 is disposed on a further back side than the light emission layer 104, that is, on a side opposite to the refractive index distribution structure 107.

The light emission layer 104 is formed by dispersing phosphor particles 105 in a background medium 106 having a same refractive index as that of the phosphor particle 105. Cases where the same refractive index as that of the phosphor particle 105 include not only a case where the refractive index is completely same as that of the phosphor particle 105, but also a case where the refractive index has a difference from that of the phosphor particle 105 within a range that the refractive index can be regarded as the same as that of the phosphor particle 105. Furthermore, it is only necessary that the refractive index be nearer that of the phosphor particle 105 than a refractive index of vacuum (1.0). The phosphor particle 105 has a particle diameter of several μm.

The refractive index distribution structure 107 is constituted by two or more media having mutually different refractive indices. The refractive index distribution structure 107 is a structure having a periodic refractive index distribution in an x-y plane along the inner face of the substrate 101, in other words, along a display screen of the image display apparatus 100. The x-y plane is parallel to the inner face of the substrate 101 if that inner face is a planar face. The refractive index distribution has a period length from a length approximately equal to a wavelength of visible light up to a length approximately several times the wavelength of the visible light.

The excitation source 103 is a layer for injecting electrons into the phosphor particles 105 to excite them so as to cause the phosphor particles 105 to emit light. The excitation source 103 is formed by, for example, arranging electron emission elements and electrodes on a front face of a substrate and providing electrodes on a back face of the light emission layer 104. Applying an electric field to the electron emission elements causes them to emit electrons toward the light emission layer 104, and supplying the electrons to the phosphor particles 105 excites them to cause light emission. The generated light is transmitted through the refractive index distribution structure 107 and the substrate 101 to exit to an external area of the image display apparatus 100, the exiting light propagating in a +z direction as display light 108.

Reasons why the image display apparatus 100 of this embodiment can improve contrast of display images will hereinafter be described.

Light (external light) entering the image display apparatus 100 from the external area is transmitted through an interface between the external area and the substrate 101 to reach the refractive index distribution structure 107. The external light that has reached the refractive index distribution structure 107 is diffracted by the periodic refractive index distribution of the refractive index distribution structure 107 to be divided into plural diffracted lights. The plural diffracted lights propagate in mutually different directions according to their diffraction orders. Of the plural diffracted lights, one light proceeding in the +z direction is referred to as “reflected diffracted light”, and one light proceeding in a −z direction is referred to as “transmitted diffracted light”.

FIG. 2 shows propagation of the reflected diffracted light generated at the refractive index distribution structure 107 when the external light 109 enters the image display apparatus 100 from the external area from a direction orthogonal to the display screen (that is, orthogonal to the substrate 101). Of the reflected diffracted light, light propagating at an angle larger than a total reflection angle at the interface between the substrate 101 and the external area is totally reflected at that interface. The totally reflected light propagates inside the substrate 101 to be attenuated without exiting to the external area. This light is referred to as “attenuated light 112”.

On the other hand, the diffracted light propagating at an angle smaller than the total reflection angle exits to the external area to become external reflected light. Such external reflected light is referred to as “external reflected light 1”. Moreover, light propagating in the direction orthogonal to the display screen is referred to as “regular (specular) reflected light 110”, and light propagating in directions other than the direction orthogonal to the display screen is referred to as “diffuse reflected light 111”.

Diffracting the external light 109 by providing the refractive index distribution structure 107 to generate the attenuated light 112 reduces an intensity of other diffracted light, which enables the external reflected light 1 exiting to the external area. Moreover, dividing the external reflected light 1 into the regular reflected light 110 and the diffuse reflected light 111 reduces the regular reflected light 110 as compared with a case where the refractive index distribution structure 107 is not provided. Providing the appropriately designed refractive index distribution structure 107 enables generation of the diffracted light, which makes it possible to reduce the external reflected light 1 or the regular reflected light 110.

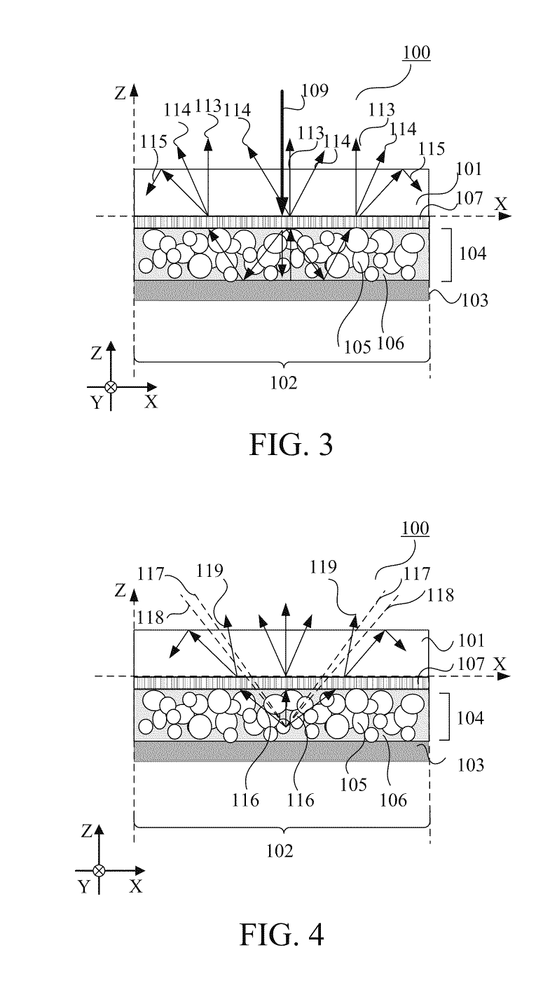

FIG. 3 shows propagation of the transmitted diffracted light generated at the refractive index distribution structure 107 when the external light 109 enters the image display apparatus 100 from the external area from the direction orthogonal to the display screen (that is, orthogonal to the substrate 101). The transmitted diffracted light is divided into plural diffracted lights of mutually different diffraction orders, the diffracted lights propagating in directions according to their diffraction orders.

As described above, the light emission layer 104 is formed as a layer in which the phosphor particles 105 are dispersed in the background medium having the same refractive index as that of the phosphor particle 105. Therefore, even though light propagates in the light emission layer 104, no diffuse refracted light is generated. Accordingly, as compared with a case where the light emission layer 104 is formed as a layer in which the phosphor particles 105 are dispersed in vacuum, the diffuse reflected light is significantly decreased.

Each diffracted light reaches the back face of the light emission layer 104 where a part thereof is reflected and another part thereof is absorbed. The reflected light propagates in the light emission layer 104 again, and then is diffracted by the refractive index distribution structure 107 to be divided into plural diffracted lights. A part of these plural diffracted lights becomes the reflected diffracted light to propagate in the light emission layer 104 in an x-y in-plane direction while repeating reflection at the back face of the light emission layer 104 and diffraction at the refractive index distribution structure 107. Then, though not shown in FIG. 3, the reflected diffracted light reaches a sidewall separating mutually adjacent pixels to be absorbed thereat.

Of the diffracted light propagating in the substrate 101, light propagating at an angle larger than the total reflection angle at the interface between the substrate 101 and the external area propagates inside the substrate 101 to be attenuated, without exiting to the external area. This light being attenuated in the substrate 101 and the light being absorbed at the back face of the light emission layer 104 and at the sidewall separating the pixels are collectively referred to as “attenuated light 115”.

On the other hand, of the diffracted light propagating in the substrate 101, light propagating at an angle smaller than the total reflection angle exits to the external area to become external reflected light 2. In the external reflected light 2, light propagating in the direction orthogonal to the display screen is referred to as “regular reflected light 113”, and light propagating in directions other than the direction orthogonal to the display screen is referred to as “diffuse reflected light 114”. Increase of the attenuated light 115 in the transmitted diffracted light reduces an intensity of the other diffracted light, so that the external reflected light 2 exiting to the external area decreases. Moreover, division of the external reflected light 2 into the regular reflected light 113 and the diffuse reflected light 114 reduces the regular reflected light 113 as compared with the case where the refractive index distribution structure 107 is not provided.

Providing the appropriately designed refractive index distribution structure 107 enables generation of the diffracted light, which makes it possible to decrease the external reflected light 2 or the regular reflected light 113.

As described above, the image display apparatus 100 of this embodiment provides the light emission layer 104 in which the phosphor particles 105 are dispersed in the background medium having the same refractive index as that of the phosphor particle 105, which can significantly decrease the diffuse reflected light generated in the light emission layer 104. Moreover, the image display apparatus 100 of this embodiment provides the appropriately designed refractive index distribution structure 107 between the substrate 101 and the light emission layer 104 to enable generation of the diffracted light, which makes it possible to generate the attenuated light. The generation of the attenuated light can decrease the external reflected light. In addition, the generation of the diffracted light at the refractive index distribution structure 107 makes it possible to divide the external reflected light into the regular reflected light and the diffuse reflected light. Such effects decrease the regular reflected light and the diffuse reflected light, which results in decrease of the external reflected light. Thus, this embodiment can realize an image display apparatus capable of displaying high contrast images.

Next, reasons why the display light increases in the image display apparatus 100 of this embodiment will be described.

FIG. 4 shows propagation of the light generated in the light emission layer 104 in the image display apparatus 100. The light generated in the light emission layer 104 includes light propagating in various directions. This light entering the refractive index distribution structure 107 is diffracted thereat to be divided into plural diffracted lights. These diffracted lights propagate in directions different from each other according to their diffraction orders. Of such diffracted lights, light propagating at an angle within the total reflection angle at the interface between the substrate 101 and the external area exits to the external area to become the display light.

In FIG. 4, an angle formed by an x-axis and a dotted line 117 shows the total reflection angle at the interface between the substrate 101 and the external area. An angle formed by the x-axis and a dotted line 118 shows a total reflection angle at an interface between the light emission layer 104 and the substrate 101 in a case where the light emission layer 104 and the substrate 101 are cemented to each other without providing the refractive index distribution structure 107.

This description focuses on light existing in the light emission layer 104 and propagating at an angle larger than the total reflection angle, such as light rays 116 shown in FIG. 4. This light is totally reflected by the interface between the substrate 101 and the external area or an interface between the light emission layer 104 and the substrate 101, without exiting to the external area. Such light becomes loss light that is not extracted to the external area if the refractive index distribution structure 107 is not provided.

On the other hand, such light entering the refractive index distribution structure 107 is diffracted thereat to be divided into plural diffracted lights. These diffracted lights propagate in mutually different directions according to their diffraction orders. A part of such diffracted lights becomes light 119 propagating in the substrate 101 at an angle within the total reflection angle to exit to the external area without receiving an influence of the total reflection at the interface between the substrate 101 and the external area. Appropriate design of the refractive index distribution structure 107 makes it possible to increase the diffracted light propagating in a direction within the total reflection angle at the interface between the substrate 101 and the external area, which enables increase of the display light exiting to the external area.

As described above, in the image display apparatus 100, the appropriately designed refractive index distribution structure 107 enables decrease of the regular reflected light and the diffuse reflected light, which enables decrease of the external reflected light and increase of the display light exiting from the light emission layer 104 to the external area. These effects can realize an image display apparatus capable of displaying high contrast images and of increasing luminance of the display light.

FIGS. 5A and 5B show an example of the refractive index distribution structure 107, FIG. 5A being an x-y plane view and FIG. 5B is an x-z plane view.

The refractive index distribution structure 107 has a structure in which, in a layer 10 formed of a first medium, columnar structural portions 11 formed of a second medium are two-dimensionally periodically arranged in the above-described x-y plane corresponding to the direction along the inner face of the substrate 101. Such a structure provides to the refractive index distribution structure 107 a two-dimensionally periodic refractive index distribution in the x-y plane.

Table 1 below shows calculation results of diffraction efficiencies and propagation angles (diffraction angles) of the reflected diffracted light and the transmitted diffracted light in a case where light of a wavelength of 550 nm enters, from the external area from a direction orthogonal to the x-y plane, the refractive index distribution structure 107 having the above-described structure and being disposed between the substrate 101 and the light emission layer 104.

In Table 1, the refractive index of the first medium in the refractive index distribution structure 107 was set to 2.3, and the refractive index of the second medium was set to 1.0. Moreover, the refractive index distribution structure 107 was formed as a triangular lattice structure (two-dimensional lattice structure) in which the columnar structural portions 11 are arranged at positions expressed by a sum or a difference of fundamental vectors A1 and A2 shown in FIG. 5A

The vector A1 is a vector of (0.5a, √3a/0.5, 0.0) and the vector A2 is a vector of (0.5a, −√3a/0.5, 0.0) when a length of a lattice period 12 is denoted by a.

The lattice period 12 was set to 1350 nm, and a diameter of the columnar structural portion 11 was set to 675 nm. A length of the refractive index distribution structure 107 in its x-z cross section was set to 900 nm.

The substrate 101 was formed of a medium having a refractive index of 1.5. The light emission layer 104 was formed by dispersing the phosphor particles 105 formed of a medium having a refractive index of 2.3 in the background medium 106 having a refractive index of 2.3. The excitation source 103 was disposed on the further back side than the light emission layer 104. Reflectance of an interface between the light emission layer 104 and the excitation source 103 was set to 80%.

The diffraction efficiency and the later-described regular reflectance, diffuse reflectance and intensity of the display light were calculated by using a transfer matrix method.

TABLE 1
DIFFRACTION EFFICIENCY OF STRUCTURE 107

| | | |
|---|---|---|
| DIFFRACTION | DIFFRACTION | DIFFRACTION |
| ORDER | ANGLE [DEG] | EFFICIENCY [%] |

REFLECTED DIFFRACTED LIGHT

| | | |
|---|---|---|
| 3 | 70.2 | 0.05 |
| 2 | 38.8 | 0.07 |
| 1 | 18.3 | 0.39 |
| 0 | 0.0 | 1.36 |
| −1 | 18.3 | 0.39 |
| −2 | 38.8 | 0.07 |
| −3 | 70.2 | 0.05 |

TRANSMITTED DIFFRACTED LIGHT

| | | |
|---|---|---|
| 3 | 37.9 | 1.01 |
| 2 | 24.1 | 0.47 |
| 1 | 11.8 | 4.89 |
| 0 | 0.0 | 41.73 |
| −1 | 11.8 | 4.89 |
| −2 | 24.1 | 0.47 |
| −3 | 37.9 | 1.01 |

As shown in Table 1, the external light entering the refractive index distribution structure 107 is divided into plural diffracted lights. The total reflection angle at the interface between the substrate 101 and the external area is 41.8°, and plus/minus third-order reflected diffracted lights have propagation angles larger than the total reflection angle at the interface between the substrate 101 and the external area. These plus/minus third-order reflected diffracted lights are totally reflected at the interface between the substrate 101 and the external area to become lights propagating and attenuating in the substrate 104. Moreover, of reflected diffracted lights from plus second-order reflected diffracted light to minus second-order reflected diffracted light, zeroth-order reflected diffracted light is the regular reflected light and the other reflected diffracted lights are the diffuse reflected light, which shows that the external reflected light is divided into the regular reflected light and the diffuse reflected light.

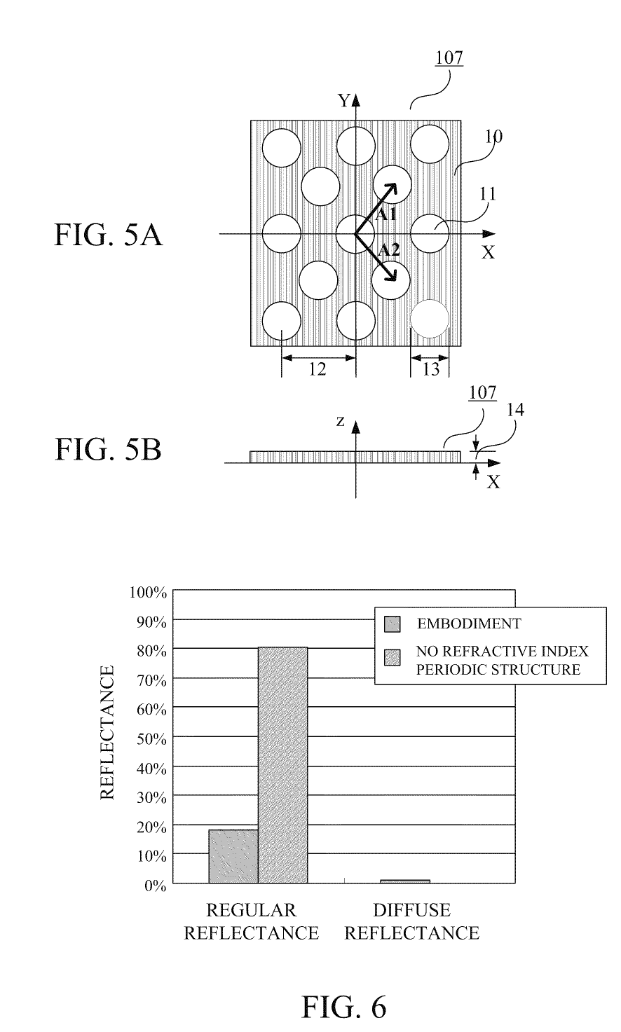

FIG. 6 shows the regular reflectance and the diffuse reflectance in the case where the light of the wavelength of 550 nm enters the image display apparatus 100 from the external area. A vertical axis shows the reflectance. The regular reflectance was calculated as a ratio of light reflected by the image display apparatus 100 in the direction orthogonal to the x-y plane to light entering the image display apparatus 100 from the direction orthogonal to the x-y plane. The diffuse reflectance was calculated as a ratio of light reflected by the image display apparatus 100 in the direction orthogonal to the x-y plane to light entering the image display apparatus 100 at an angle of 45° with respect to the z-axis in the x-z plane.

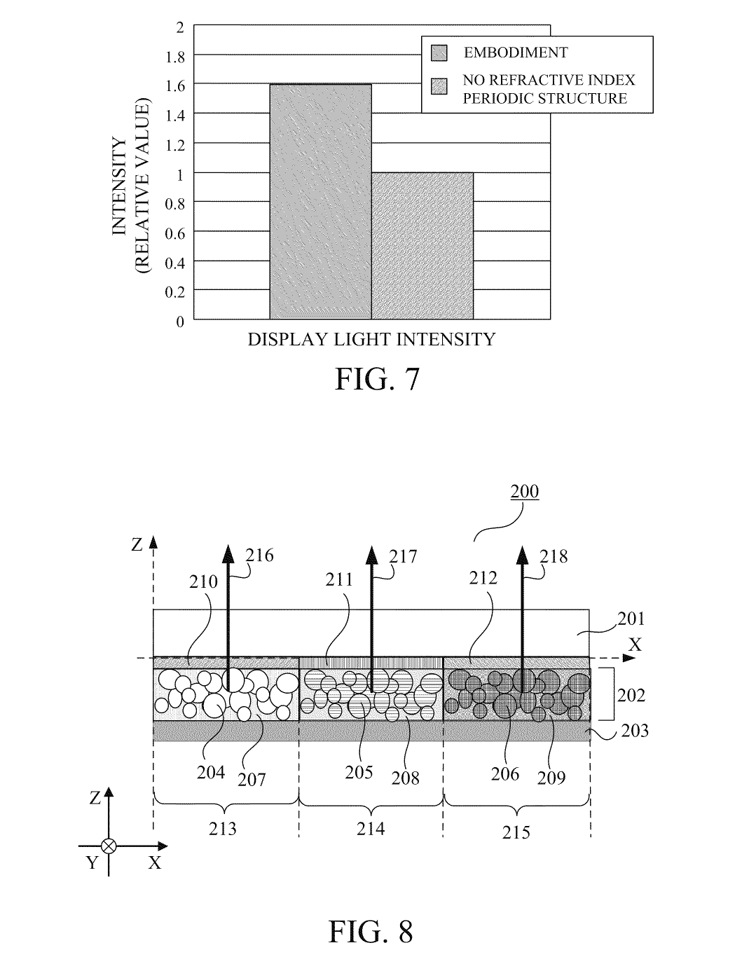

FIG. 7 shows the intensity of the display light exiting to the external area in a case of generating light inside the light emission layer 104 toward the external area. The intensity of the display light was calculated by integrating all exiting light extracted to the external area. Values of the intensity of the display light shown along a vertical axis in FIG. 7 are values normalized by a value of the intensity of the display light when the refractive index distribution structure 107 is not provided. Moreover, FIGS. 6 and 7 also show values of the regular reflectance and the diffuse reflectance in the case where the refractive index distribution structure 107 is not provided.

As shown in FIG. 6, providing the refractive index distribution structure 107 enables significant reduction of the regular reflectance as compared with a case of not providing the refractive index distribution structure 107. This is because the provision of the refractive index distribution structure 107 enables the division of the external reflected light into the regular reflected light and the diffuse reflected light. Moreover, the value of the intensity of the display light in FIG. 7 shows that the provision of the refractive index distribution structure 107 enables significant increase of the intensity of the display light.

As described above, the image display apparatus 100 of this embodiment uses the background medium 106 formed of the medium having the same refractive index as that of the phosphor particle 105, and provides the refractive index distribution structure 107 shown in FIGS. 5A and 5B between the substrate 101 and the light emission layer 104, thereby enabling the decrease of the external reflected light. In addition, the image display apparatus 100 enables, by providing the refractive index distribution structure 107, increase of the display light exiting from the light emission layer 104 to the external area. These effects make it possible to realize an image display apparatus capable of displaying high contrast and bright images.

The excitation source 103 may have a configuration in which electrodes are arranged on the substrate, and cells and electrodes are arranged on the front face or back face of the light emission layer 104.

The cell encloses gas that generates plasma in response to electric current application to generate ultraviolet light. The phosphor particles 105 are irradiated with the ultraviolet light generated from the gas, thereby being excited.

The refractive index distribution structure 107 is not limited to the structure shown in FIGS. 5A and 5B, and may be a structure having structural parameters different from those shown in FIGS. 5A and 5B. The above-described triangular lattice structure has a good structural symmetry and thereby has a small dependency on incident angle of light entering the refractive index distribution structure, so that the triangular lattice structure can decrease angular dependencies of the intensities of the external reflected light and the display light that exit from the image display apparatus 100.

However, the refractive index distribution structure 107 may have a two-dimensional lattice structure other than the triangular lattice structure, such as a square lattice structure and a rectangular lattice structure. Such structures can be easily formed by applying a resist on a substrate to be processed, performing two-light flux interference exposure and development thereon twice to form a resist mask with patterns, and then etching the substrate.

Moreover, the refractive index distribution structure 107 may be a structure having a one-dimensional periodic refractive index distribution or a three-dimensional periodic refractive index distribution. Furthermore, the refractive index distribution structure 107 may be formed of three or more media having mutually different refractive indices or a same medium as the background medium 106 or that of the substrate 101.

The phosphor particle 105 and the background medium 106 constituting the light emission layer 104 may be formed of a medium other than the medium having the above-described refractive index. Moreover, the refractive index of the substrate 101 and the reflectance of the interface between the light emission layer 104 and the excitation source 103 are not limited to the values shown in this embodiment.

### Embodiment 2

FIG. 8 shows a configuration of an image display apparatus 200 that is a second embodiment (Embodiment 2) of the present invention. FIG. 8 shows an x-z cross section of the image display apparatus 200.

The image display apparatus 200 is constituted by a substrate 201, and pixels 213, 214 and 215 that are arranged on a further inner side than the substrate 201 and respectively display red, green and blue. The red, green and blue respectively correspond to a first color, a second color and a third color, and the pixels 213, 214 and 215 respectively correspond to a first pixel, a second pixel and a third pixel. Although this embodiment describes the case where the pixels 213, 214 and 215 display red, green and blue, these pixels may display other colors.

Although FIG. 8 shows respective ones of the pixels 213, 214 and 215 for the respective colors, two-dimensionally arranging pluralities of the pixels 213, 214 and 215 along an inner face of the substrate 101 can cause the image display apparatus 200 to display two-dimensional color images.

The substrate 201 is formed of a visible light transmissive (transparent) medium such as glass or plastic.

The pixels 213, 214 and 215 are constituted by light emission layers 202, refractive index distribution structures 210, 211 and 212 that are minute periodic structures, and excitation sources 203. The light emission layers 202 and the refractive index distribution structures 210, 211 and 212 in the respective pixels 213, 214 and 215 have mutually different configurations.

The refractive index distribution structures 210, 211 and 212 are disposed between the substrate 201 and the light emission layers 202. The excitation sources 203 are disposed on a further back side than the light emission layers 202 (that is, on a side opposite to the refractive index distribution structures 210, 211 and 212).

In the light emission layers 202 of the pixels 213, 214 and 215, phospher particles 204, 205 and 206 respectively generating light of a red wavelength, light of a green wavelength and light of a blue wavelength are dispersed in background media 207, 208 and 209. The phospher particles 204, 205 and 206 have mutually different refractive indices, and the background media 207, 208 and 209 have same refractive indices as those of the phospher particles 204, 205 and 206, respectively. In other words, the background media 207, 208 and 209 also have mutually different refractive indices. The meaning of the “same refractive index” is same as that described in Embodiment 1.

However, it is not necessarily needed that the refractive indices of the phospher particles 204, 205 and 206 and the background media 207, 208 and 209 are mutually different, and it is only necessary that the refractive index of the phospher particle and the background medium in one of the pixels 213, 214 and 215 be different from that of at least one of the other pixels.

Moreover, each of the refractive index distribution structures 210, 211 and 212 is formed of two media having mutually different refractive indices, and has a structure two-dimensionally periodically arranged in an x-y plane corresponding to a direction along the inner face of the substrate 201. Such a structure of each of the refractive index distribution structures 210, 211 and 212 provides two-dimensional periodic refractive index distribution in the x-y plane to each refractive index distribution structure. The refractive index distribution of each refractive index distribution structure has a period length from a length approximately equal to a wavelength of visible light up to a length approximately several times the wavelength of the visible light.

However, it is not necessarily needed that the refractive index distribution structures 210, 211 and 212 have mutually different structures, and it is only necessary that the structure of one of the refractive index distribution structures 210, 211 and 212 be different from that of at least one of the other refractive index distribution structures.

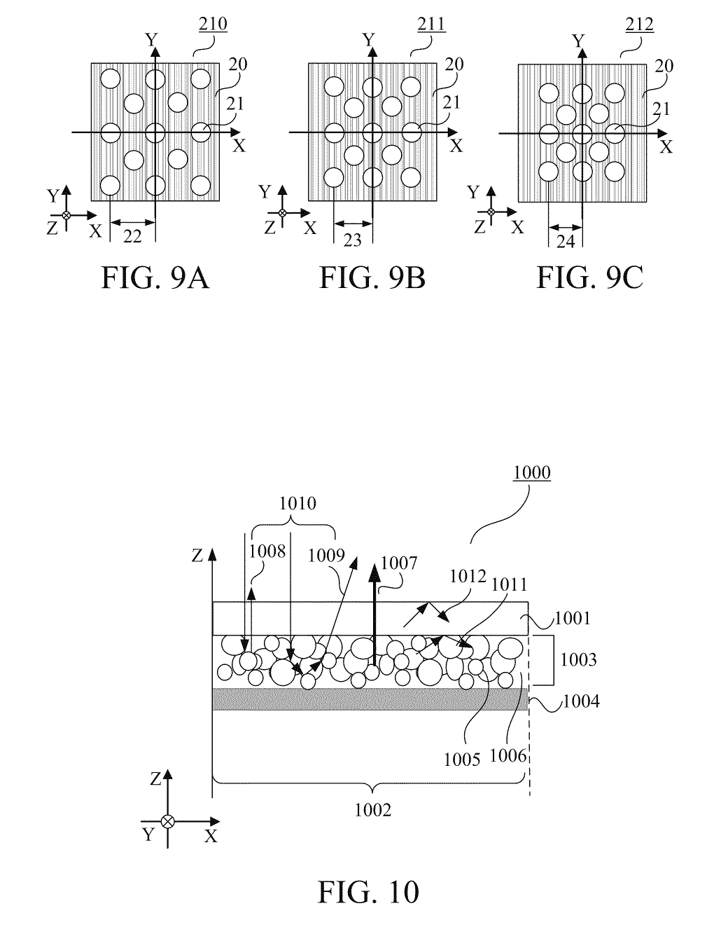

FIGS. 9A, 9B and 9C respectively show examples of the refractive index distribution structures 210, 211 and 212. The refractive index distribution structures 210, 211 and 212 have a same length in a y-z cross section, and have mutually different structures in the x-y plane. Each of the refractive index distribution structures 210, 211 and 212 has a triangular lattice structure in which, in a layer 20 formed of a first medium, columnar structural portions 211 formed of a second medium are two-dimensionally periodically arranged in the x-y plane. The refractive index distributions of the refractive index distribution structures 210, 211 and 212 have mutually different periods 22, 23 and 24.

The excitation sources 203 are layers for exciting the phospher particles 204, 205 and 206 to cause light emission. Each of the excitation sources 203 is formed by arranging electron emission elements and electrodes on a front face of a substrate and providing electrodes on a back face of the light emission layer 202. Applying an electric field to the electron emission elements causes them to emit electrons toward the light emission layer 202, and supplying the electrons to the phosphor particles 204, 205 and 206 excites them to cause light emission. The lights emitted from the phosphor particles 204, 205 and 206 are transmitted through the refractive index distribution structures 210, 211 and 212 and the substrate 201 to exit to an external area as display lights 216, 217 and 218.

As described above, in the image display apparatus 200 of this embodiment, the refractive indices of the phospher particles 204, 205 and 206 and the background media 207, 208 and 209 in the red, green and blue pixels 213, 214 and 215 are mutually different. Use of such different background media 207, 208 and 209 for the respective pixels 213, 214 and 215 makes it possible to reduce a refractive index difference of each of the background media 207, 208 and 209 from each of the phospher particles 204, 205 and 206 dispersed therein as compared with a case of using background media having a mutually same refractive index, which enables further suppression of generation of the diffuse reflected light described in Embodiment 1. Therefore, an image display apparatus capable of displaying high contrast images can be obtained.

Moreover, as described above, in the image display apparatus 200 of this embodiment, the refractive index distribution structures 210, 211 and 212 included in the respective pixels 213, 214 and 215 have mutually different structures. Since the phospher particles 204, 205 and 206 and the background media 207, 208 and 209 have mutually different refractive indices, effective refractive indices of the light emission layers 202 in the respective pixels 213, 214 and 215 are also mutually different. The wavelengths of the light generated from the phospher particles 204, 205 and 206 are also mutually different.

In general, diffraction efficiencies and diffraction angles of the reflected diffracted light and the transmitted reflected light, which were described in Embodiment 1, at a periodic refractive index distribution structure are decided based on not only structural parameters of the refractive index distribution structure, but also refractive indices of a reflecting side medium and a transmitting side medium, and a wavelength of entering light. As described in Embodiment 1, the variation of the diffraction efficiency and diffraction angle changes the intensities of the regular reflected light, the diffuse reflected light and the display light. Therefore, this embodiment appropriately designs the refractive index distribution structure for each pixel in view of the effective refractive index and a light emission wavelength of the light emission layer included in each pixel. Such appropriate design of the refractive index distribution structure enables improvement of an effect to suppress the regular reflected light and the diffuse reflected light and an effect to increase the display light, as compared with a case of providing refractive index distribution structures having a mutually same refractive index for the respective pixels. Thereby, this embodiment can realize an image display apparatus capable of displaying high contrast images and increasing the display light.

Although this embodiment described, as Embodiment 1, the case where the refractive index distribution structure is formed as the triangular lattice structure, the refractive index distribution structure may be a square lattice structure or a rectangular lattice structure, and may be one- or three-dimensional refractive index distribution structure. Furthermore, the refractive index distribution structure may be formed of three or more media having mutually different refractive indices or a same medium as the background medium or that of the substrate.

Moreover, in the first to third pixels, the light emission layers may use background media having a mutually same refractive index with refractive index distribution structures having mutually different structures, or may use refractive index distribution structures having a mutually same structure with background media having mutually different refractive indices. Furthermore, thicknesses of the refractive index distribution structures provided in the respective pixels in the y-z cross section may be mutually different.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-296242, filed on Dec. 25, 2009, which is hereby incorporated by reference herein in its entirety.

What is claimed is:

1. An image display apparatus comprising:
a light transmissive substrate; and
plural pixels arranged on a further inner side than the substrate,
wherein each pixel comprising:
a light emission layer in which phosphor particles are dispersed in a background medium having a same refractive index as that of the phosphor particle;
an excitation source exciting the phosphor particles to cause them to emit light; and
a refractive index distribution structure disposed between the substrate and the light emission layer, and having a periodic refractive index distribution in a direction along an inner surface of the substrate.

2. An image display apparatus according to claim 1, wherein the refractive index distribution structure has a two-dimensional lattice structure in the direction along the inner surface of the substrate.

3. An image display apparatus according to claim 1, wherein the plural pixels includes a first pixel, a second pixel and a third pixel for respectively displaying a first color, a second color and a third color, and
wherein one of the first, second and third pixels has a refractive index distribution structure different from that of at least one of the other pixels.

4. An image display apparatus according to claim 1, wherein the plural pixels includes a first pixel, a second pixel and a third pixel for respectively displaying a first color, a second color and a third color, and
wherein the refractive index of the phosphor particle and the background medium in one of the first, second and third pixels is different from that in at least one of the other pixels.
